(19) United States
(12) Patent Application Publication
(10) Pub. No.: US 2009/0007616 A1
(43) Pub. Date: Jan. 8, 2009

(54) METHOD OF INHIBITING CORROSION ON FERROUS METAL SURFACES IN CONTACT WITH NITROGEN FERTILIZER SOLUTIONS

(76) Inventors: Phillip E. Bureman, Olathe, KS (US); Donald A. Johnson, Batavia, IL (US); David A. Grattan, Bolingbrook, IL (US)

Correspondence Address: Edward O. Yonter;Patent and Licensing Department, Nalco Company, 1601 West Diehl Road, Naperville, IL, 60563-1198, US

(21) Appl. No.: 11/774,169

(22) Filed: Jul. 6, 2007

(51) Int. Cl. C05G 3/00; C05C 3/00; C05C 9/00

(52) U.S. Cl. 71/30; 71/27

(57) ABSTRACT

A method of using trace amounts of certain compounds to reduce or inhibit corrosion on metal surfaces exposed to corrosive materials is disclosed. The compounds include hydroxlamines, acrylate polymers or copolymers, certain organic acids, tannic acid, carbohydrazide and its derivates and salts, and combinations of these compounds. The metal surfaces may include any ferrous metal piping or equipment surfaces, such as that used during storage, transport, and other processing of such materials. A corrosion-inhibited UAN solution having about 20 to about 50 percent by weight water and from less than 10 to about 1,000 ppm of one or more of the described corrosion inhibitors, and a pH from about 7 to about 8 is also disclosed.

### TECHNICAL FIELD

This invention relates generally to methods of inhibiting corrosion on ferrous metal surfaces exposed to corrosive materials. More specifically, the invention relates to blending one or more corrosion-inhibiting compounds with a nitrogen fertilizer solution to prevent corrosion on ferrous metal surfaces in contact with the solution. The invention has particular application in urea ammonium nitrate fertilizer solution storage and transport vessels and equipment used to transfer such solutions.

### BACKGROUND

Storing and transporting corrosive materials, such as fertilizer solutions, nitrogen-based solutions, ammonia solutions, urea ammonium nitrate (“UAN”), and the like creates a variety of problems. The magnitude of these problems increases with the corrosiveness of the materials. Some substances produce a considerable amount of corrosion damage, requiring repair of the transport or storage container or piping equipment. Similar corrosiveness issues exist for the storage and transport of a variety of materials. Corrosion issues in vessels that hold UAN solutions are of particular relevance due to its commercial popularity and economical use in agricultural applications. As an exemplary corrosive material, a description of UAN and related corrosion issues is provided below.

The production of UAN solutions includes blending urea solution, ammonium nitrate solution, and additional water in either a batch or continuous process. Ammonia is sometimes added to the UAN to act as a pH buffer UAN is typically manufactured with about 20 weight percent water and for field applications is generally diluted with water to about 29 to 30 weight percent water. The former is generally referred to as UAN 32 (32 percent total nitrogen content), which typically has about 45 weight percent ammonium nitrate, about 35 weight percent urea, and about 20 weight percent water. The latter is generally referred to as UAN 28 (28 percent total nitrogen content), which typically has about 39 weight percent ammonium nitrate, about 31 weight percent urea, and about 30 weight percent water. Such UAN solutions are economically desirable as compared to solids, for example, because herbicides can be blended with UAN allowing for one pass application of both fertilizer and herbicide.

A persistent problem in the production, storage, transport, and application of UAN is its corrosiveness towards ferrous metals. The solutions are quite corrosive towards, for example, mild steel (e.g., up to 500 mils per year (“MPY”) on C1010 steel) and are therefore usually treated by the producer with a bulk corrosion inhibitor to protect tanks, pipelines, railcars, barges, and application equipment, such as spray nozzles, etc. In particular, rust and corrosion on the inner surface of storage and transport vessels, as well as piping systems used to fill or empty the vessels, is a major problem. Corrosion products, such as sludge, can also plug spray nozzles in fertilizer application equipment and irrigation booms. Without adequate corrosion inhibition, UAN solutions in storage and transport vessels can become discolored in a short period. For example, bloom rust formation in railcars leads to UAN solutions developing a red or orange hue. UAN is normally a clear liquid, so such discoloration is undesirable and in many cases leads to product waste.

Corrosion in UAN transporting railcars also creates a wide variety of logistical problems. Railcars are typically subject to routine inspection (every 10 years in North America). Before a railcar can be inspected or repaired, the entire inner surface of the car must be cleaned, typically by sandblasting, an expensive and time-consuming process. In addition, such sand or grit blasting of the railcar's interior usually removes existing corrosion inhibition films as well as natural and created passivation layers. This removal exposes bare metal and makes the interior walls susceptible to flash corrosion, even in just a humid air environment. Upon return to corrosive UAN service, severe corrosion becomes a big concern.

It is therefore highly desirable to keep the inner surface of the railcar in clean, rust-free, and corrosion-free condition while the railcar awaits return to service. Further, if a fresh load of UAN is added to a railcar that has bloom rust on its inner surface or a rusty heel of old UAN pooled on the bottom of the railcar as sludge, the entire load could be discolored. This discoloration may cause point-of-delivery rejection, which creates extra expenses for return and replacement and causes product waste. Such an occurrence could also damage the quality reputation of the UAN supplier.

General remedies used in the past to inhibit UAN-caused corrosion include high levels (usually hundreds or thousands of mg/kg) of phosphate, alkyl phosphate esters, ethoxylated alkyl phosphates, or polyphosphate salts added directly to the UAN solution to serve as bulk corrosion inhibitors. These remedies fell into disfavor because the phosphates precipitated with other constituents, such as iron, calcium, magnesium, etc. Such precipitates led to unfavorable deposits on the bottom of vessels (as described above) as well as plugging of spray application devices.

Other well-known corrosion inhibitors, such as molybdate and tungstate (See U.S. Pat. No. 5,376,159 and U.S. Pat. App. No. 2006/0237684 A1, respectively) have also found application in UAN service. In addition to the above-described bulk corrosion inhibitors directly added to the UAN solution, vessel coatings have also been developed in an attempt to prevent and inhibit corrosion. Such coatings provide a layer on the inner surface of a vessel to prevent contact of the UAN with the inner surface of the vessel.

There thus exists an ongoing need to provide improved corrosion resistance for storage and transport vessels and piping equipment used in corrosive service. In particular, there exists a need to inhibit corrosion in stationary and mobile transport vessels that hold nitrogen-based solutions and other corrosive materials, including pipelines used to transfer such materials.

### SUMMARY

This disclosure provides a method using trace amounts of certain hydroxlamines, acrylate polymers or copolymers, certain organic acids, tannic acid, carbohydrazide and its derivates and salts, and combinations of these compounds to reduce or inhibit corrosion on metal surfaces exposed to corrosive materials. The metal surfaces may include any ferrous metal piping or equipment surfaces, such as that used during storage, transport, and other processing of such materials. A typical corrosive material is nitrogen fertilizer solution, such as urea ammonium nitrate (“UAN”) with water content from about 20 to about 50 percent by weight. In a preferred embodiment, corrosion-inhibited UAN is non-sludging, non-foaming, and essentially precipitate free.

In an aspect, the invention provides an improved method of inhibiting corrosion on metal surfaces exposed to a corrosive material. The method generally includes the steps of adding an effective amount of one or more of the described corrosion-inhibitive compounds to the material. If the corrosive material is a nitrogen fertilizer solution, the pH of the resultant blend is optionally adjusted with ammonia. Preferably, the pH is adjusted to be between about 7 and about 8. The method may be used in a variety of storage, processing, and application areas in corrosive service. For example, the method may include storing or transporting inhibited fertilizer solution in ferrous metal piping and/or containers. The solution may then be diluted and still remain effectively corrosion-inhibited while applying to cropland with ferrous metal equipment.

In another aspect, the invention provides a corrosion-inhibited UAN solution having about 20 to about 50 percent by weight water and from less than 10 to about 1,000 ppm of one or more of the described corrosion inhibitors and a pH from about 7 to about 8. In an embodiment, the pH is about 7 to 7.5. In another embodiment, the pH is about 7.8 to 8. This corrosion-inhibited liquid UAN fertilizer may be stored, transported, and/or applied to croplands.

It is an advantage of the invention to provide a method of inhibiting corrosion on ferrous metal surfaces in contact with corrosive materials, such as UAN solutions.

It is another advantage of the invention to provide a corrosion-inhibited urea ammonium nitrate fertilizer solution having trace amounts of corrosion-inhibiting compounds.

A further advantage of the invention is to improve product quality (e.g., clarity due to the absence of rust which causes reddening of the material within the vessel) and to reduce corrosion of surfaces in contact with corrosive materials, leading to concomitant increases in profitability.

Additional features and advantages are described herein, and will be apparent from the following Detailed Description and Examples.

### DETAILED DESCRIPTION

As used herein, “nitrogen fertilizer solution” includes any of a variety of fertilizers including “UAN.” UAN means any grade of fertilizer solution having a mixture of urea and ammonium nitrate in water including common grades of UAN 18, UAN 28, and UAN 32, where the numbers indicate total nitrogen content. The UAN preferably includes from about 20 to about 50 percent by weight water.

“Corrosive substances or materials” and similar terms include, but are not limited to solutions, such as fertilizer, nitrogen-based, urea ammonium nitrate, aqua ammonia, urea liquor, ammonium sulfate, ammonium thiosulfate, ammonium thiophosphate, ammonium chloride, potassium sulfate, potassium chloride, and other similar materials. The embodiments herein depict UAN as the target material but have equal application in other corrosive materials. Though the invention is generally applicable to any corrosive substance, it has specific applicability to UAN fertilizer solutions. It is intended, however, that the invention is useful in all varieties and concentrations of corrosive materials as well as a full range of dilute and concentrated UAN solutions.

In an embodiment, the corrosion inhibitor includes carbohydrazide and/or its water-soluble salts. In a preferred embodiment, the carbohydrazide is in a solution of at least about 5 weight percent and up to about 100 weight percent. In another embodiment, the carbohydrazide solution is less than 5 weight percent. The carbohydrazide may also be used in solid form.

In another embodiment, the corrosion inhibitor is an organic acid, such as ascorbic acid, erythorbic acid and/or salts thereof. In this embodiment, the corrosion inhibitor may be in a solution of about 10 weight percent to about 33 weight percent. In an embodiment, this solution is more dilute and less than 10 weight percent. Alternatively, the ascorbic/erythorbic acid may be added in solid form to the nitrogen fertilizer solution.

In one embodiment, the corrosion inhibitor is a hydroxylamine or mixtures of such compounds. A preferred hydroxylamine has the general formula (R1R2)-N—O—(R3), where R1, R2, and R3 may either be the same or different. According to alternative embodiments, they may be hydrogen or lower alkyls containing from 1 to about 6 (more preferably 1 to 3) carbon atoms, or a water-soluble salt thereof. Typical water-soluble salts are phosphate, sulfate, and chloride salts, although others are also contemplated for use in the invention. In some embodiments, the hydroxylamine is preferably used without these salts, in order to minimize added ionic material in the UAN. In a preferred embodiment, the hydroxylamine is in a solution of at least about 5 weight percent and up to about 100 weight percent. In an embodiment, the hydroxylamine is in a solution from about 6.5 to about 8.5 weight percent. In a further embodiment, the hydroxylamine is a dilute solution of less than 6.5 weight percent. It may also be added in solid form.

A preferred hydroxylamine is N,N-diethylhydroxylamine (DEHA). Other representative hydroxylamines include N,N-methylethylhydroxylamine, N,N-dimethylhydroxylamine, N,N-methylpropylhydroxylamine, N-ethylhydroxylamine, O-ethyl-N,N-dimethylhydroxylamine, O-methyl-N,N-diethylhydroxylamine, O-methylhydroxylamine, their salts, the like, and combinations thereof.

In another embodiment, the corrosion-inhibiting composition includes at least one polymer selected from the group consisting of polyacrylic acids, acrylamidelacrylic acid copolymers, and salts of these polymers and copolymers. Acrylamide/acrylic acid copolymers and their salts are preferred. It is contemplated that any ratio of acrylamide to acrylic acid may be used for the copolymer. The copolymer preferably comprises about 5% by weight to about 95% by weight of acrylic acid, more preferably about 30% by weight to about 50% by weight acrylic acid. It should be appreciated that the polymer, copolymer, and/or the corresponding salt can be used in the method of the invention.

The molecular weight of the polymers or copolymers may be from about 20,000 to greater than 2,000,000. The polymers useful in the present invention can have molecular weight of at least about 50,000 or at least about 100,000 or at least about 200,000. The molecular weight can also be as high as 750,000; 1,500,000; 2,000,000; or can be as high as about 5,000,000. One preferred range is from about 20,000 to about 5,000,000. Another preferred range is from about 100,000 to about 1,000,000. A further preferred range is from about 200,000 to about 750,000.

The amount of corrosion-inhibitor used may be less than 10 ppm. In an embodiment, from about 10 ppm to about 100 ppm of the corrosion inhibitor is added to the corrosive material. In a further embodiment, from about 100 or 200 up to about 500 or 1,000 ppm of the corrosion inhibitor is used. It should be appreciated that any of the described corrosion inhibitors may be mixed with each other and/or added to the corrosive material either simultaneously or sequentially.

In alternative embodiments, monitoring the corrosion-inhibiting composition dosage and concentration in the nitrogen fertilizer solution includes using molecules having fluorescent or absorbent moieties (i.e., tracers). Such tracers are typically inert and added to the nitrogen fertilizer solution in a known proportion to the corrosion-inhibiting composition. The fluorescent tracer may be added with the corrosion inhibitor either simultaneously or sequentially, being either mixed with the corrosion inhibitor or separate. “Inert” as used herein means that an inert tracer (e.g., an inert fluorescent tracer) is not appreciably or significantly affected by any other chemistry in the solution, or by other parameters, such as temperature, pressure, alkalinity, solids concentration, and/or other parameters. “Not appreciably or significantly affected” means that an inert fluorescent compound has no more than about 10 percent change in its fluorescent signal, under conditions normally encountered in nitrogen fertilizer or other corrosive solutions.

Representative inert fluorescent tracers suitable for use in the method of the invention include 1,3,6,8-pyrenetetrasulfonic acid, tetrasodium salt (CAS Registry No. 59572-10-0); monosulfonated anthracenes and salts thereof, including, but not limited to 2-anthracenesulfonic acid sodium salt (CAS Registry No. 16106-40-4); disulfonated anthracenes and salts thereof (See U.S. Pat. App. No. US 2005/0025659 A1, incorporated herein by reference in its entirety); fluorescent tracers as listed in U.S. Pat. No. 6,966,213 B2 (incorporated herein by reference in its entirety); other suitable fluorescent compounds; and combinations thereof. These inert fluorescent tracers are either commercially available under the tradename TRASAR® from Nalco Company® (Naperville, Ill.) or may be synthesized using techniques known to persons of ordinary skill in the art of organic chemistry.

Monitoring the concentration of the tracers using light absorbance or fluorescence allows for precise control of the corrosion-inhibiting composition dosage. For example, the fluorescent signal of the inert fluorescent chemical may be used to determine the concentration of the corrosion-inhibiting composition or compound in the corrosive solution. The fluorescent signal of the inert fluorescent chemical is then used to determine whether the desired amount of the corrosion-inhibiting composition or product is present in the solution and the feed of the composition can then be adjusted to ensure that the desired corrosion-inhibitive amount of the composition is present in the corrosive solution.

### EXAMPLES

The foregoing may be better understood by reference to the following examples, which are intended for illustrative purposes and are not intended to limit the scope of the invention.

In the following examples, a nitrogen fertilizer tank corrosion simulator (NCS S”) was used. The simulator included a series of 500 ml flasks placed on a conventional hotplate while maintaining a temperature of about 160° F. to 180° F. A UAN 32 solution with a pH in the range of about 7 to 8 was obtained from an industrial source and used for samples in the tables below. Mild steel test coupons were placed in the solution and exposed to the UAN 32 in the NCS for the indicated number of days. On top of each flask were a water-cooled condenser system and an air injection manifold. The condenser system prevented water loss of any critical corrosion parameters from within the flasks. Such losses would have altered concentrations in the samples and produced erroneous results. Air injection helped to simulate accelerated corrosion stress.

Compounds used in the examples are as follows. Molybdate ion was provided by an about 35 weight percent aqueous solution of sodium molybdate. The carboxylic acid was a solution of about a 10 weight percent erythorbic acid. The sodium nitrate was about a 40 weight percent solution. Carbohydrazide was an approximately 6.5 weight percent solution. Am/Ac was an acrylamidelacrylic acid copolymer in a solution of about 32 weight percent. DEHA was a solution of about 85 weight percent N,N-diethyl hydroxylamine. EA was a solution of about 9.9 weight percent erythorbic acid.

The corrosion rate for the following samples was based on coupon weight and is presented as mils per year in the tables below for various reductants, dispersants, other compounds, and combinations. Total solution iron levels (a corrosion indicator) were measured for certain samples. Though any suitable test method may be used to determine such iron levels, Ferrozine calorimetric analysis method was used (available from Hach, Inc., Loveland, Colo.).

### Example 1

The duration for this Example was 10 days at a temperature of 180° F.

TABLE 1

| | Corrosion |
|---|---|
| Treatment | Rate |
| Blank | 308 |
| Molybdate (100 ppm) | 0.02 |
| EA (100 ppm) | 184 |
| Sodium Nitrite (600 ppm) | 339 |

### Example 2

The test coupons for this Example were exposed the UAN 32 solution for about 6 days at a temperature of 160° F.

TABLE 2

| | Corrosion | |
|---|---|---|
| Treatment | Rate | Fe²⁺ (ppb) |
| Carbohydrazide (104 ppm) | 0 | <100 ppb |
| Molybdate (99 ppm) | 0.18 | <100 ppb |
| Molybdate (50 ppm) | 1 | ~800 ppb |
| Am/Ac (100 ppm) | | |
| Phosphoric acid (614 ppm) | 69 | Not tested |

### Example 3

The duration for this Example was 2 days of exposure to the UAN 32 solution with a temperature of about 160° F. It should be noted that the tannic acid sample exhibited a dark blue tinge.

TABLE 3

| | Corrosion |
|---|---|
| Treatment | Rate |
| Blank | 812 |
| DEHA (100 ppm) | 575 |
| Gallic acid (102 ppm) | 428 |
| Tannic acid (100 ppm) | 0 |

### Example 4

The test duration for this Example was 2 days.

TABLE 4

| | Corrosion | |
|---|---|---|
| Treatment | Rate | Fe²⁺ |
| Carbohydrazide (101 ppm) | 0 | <100 ppb |
| Carbohydrazide (74 ppm) | 0.13 | <100 ppb |
| Molybdate (50 ppm) | | |
| Carbohydrazide (49 ppm) | 3 | Not tested |
| Molybdate (50 ppm) | | |
| Carbohydrazide (25 ppm) | 2 | Not tested |
| Molybdate (74 ppm) | | |

### Example 5

The test duration for this Example was 6 days.

TABLE 5

| | Corrosion | |
|---|---|---|
| Treatment | Rate | Fe²⁺ |
| Am/Ac (100 ppm) | 0 | <150 ppb |
| Am/Ac (100 ppm) | 155.18 | Not tested |
| Carbohydrazide (100 ppm) | | |
| Am/Ac (50 ppm) | 214 | Not tested |
| Carbohydrazide (50 ppm) | | |
| Am/Ac (24 ppm) | 383 | Not tested |
| Carbohydrazide (75 ppm) | | |

### Example 6

The duration for these samples was either 3 or 6 days, as indicated below in Table 6. It is of note that after this test, the flasks having the 3-day samples with the 101 ppm acrylate polymer and the combination 75 ppm modified amine/25 ppm molybdate were rinsed one time with water. After rinsing, the acrylate sample had significantly less of a film remaining on the wall of the flask, which is of importance when considering corrosion impacts and residues remaining on the surfaces of UAN storage and transport equipment.

TABLE 6

| | Corrosion | Duration |
|---|---|---|
| Treatment | Rate | (days) |
| Am/Ac (101 ppm) | 125 | 6 |
| Molybdate (100 ppm) | 0.08 | 6 |
| Carbohyrazide (100 ppm) | 0 | 6 |
| Molybdate (25 ppm) | 356 | 6 |
| Carbohydrazide (75 ppm) | | |
| Am/Ac (101 ppm) | 93 | 3 |
| Molybdate (25 ppm) | 243 | 3 |
| Carbohydrazide (75 ppm) | | |

It should be understood that those skilled in the art would find apparent various changes and modifications to the described embodiments. Such changes and modifications can be made without departing from the spirit and scope of the invention and without diminishing its intended advantages. It is therefore intended that such changes and modifications be covered by the appended claims.

The claimed invention is:

1. A method of inhibiting corrosion of a ferrous metal surface exposed to a corrosive material, the method comprising adding an effective amount of a corrosion inhibitor selected from the group consisting of: carbohydrazide and/or salts thereof; hydroxlamines; acrylate polymers; ascorbic acid and/or salts thereof; erythorbic acid and/or salts thereof; tannic acid; and combinations thereof to the corrosive material to form a blend; if the corrosive material is a nitrogen fertilizer solution, optionally adjusting the pH of the blend by adding ammonia; and contacting the blend with the ferrous metal surface.

2. The method of claim 1, wherein the nitrogen fertilizer solution has from about 20 to about 50 percent by weight water.

3. The method of claim 1, wherein the nitrogen fertilizer solution is a urea ammonium nitrate fertilizer solution.

4. The method of claim 1, wherein the corrosion inhibitor is selected from the group consisting of: a solution of at least about 5 weight percent up to about 100 weight percent carbohydrazide and solid carbohydrazide.

5. The method of claim 1, wherein the acrylate polymer is a copolymer of acrylamide and acrylic acid.

6. The method of claim 1, wherein the ascorbic acid and/or erythorbic acid is in a solution of at least about 10 weight percent to about 33 weight percent.

7. The method of claim 1, wherein the hydroxylamine is N,N-diethyl bydroxylamine.

8. The method of claim 8, wherein the N,N-diethyl hydroxylamine is in a solution of about 85 weight percent.

9. The method of claim 1, including mixing less than 10 ppm of the corrosion inhibitor with the nitrogen fertilizer solution to form the blend.

10. The method of claim 1, including mixing from about 10 ppm to about 100 ppm of the corrosion inhibitor with the nitrogen fertilizer solution to form the blend.

11. The method of claim 1, including mixing from about 10 ppm to about 1,000 ppm of the corrosion inhibitor with the nitrogen fertilizer solution to form the blend.

12. The method of claim 1, including adjusting the pH of the blend to be from about 7 to about 8.

13. The method of claim 1, including adding a known proportion of an inert fluorescent tracer with the corrosion inhibitor either simultaneously or sequentially, being either mixed with the corrosion inhibitor or separate.

14. A urea ammonium nitrate fertilizer solution consisting of about 20 to about 50 percent by weight water and from less than 10 to about 1,000 ppm corrosion inhibitor selected from the group consisting of carbohydrazide, acrylate polymers, ascorbic acid, erythorbic acid, tannic acid, hydroxylamines, and combinations thereof; wherein said solution has a pH from about 7 to about 8 and is characterized by reduced corrosion towards ferrous metal surfaces.
